(19) United States
(12) Patent Application Publication
(10) Pub. No.: US 2026/0187465 A1
(43) Pub. Date: Jul. 2, 2026

(54) SYSTEM AND METHOD FOR TRAINING DEEP SET NEURAL NETWORKS ON SYNTHETIC DATAPOINTS BY AUGMENTING TRAINING DATASETS

(71) Applicant: Optum, Inc., Minnetonka, MN (US)

(72) Inventors: Brian Lawrence Hill, Culver City, CA (US); Josue Nassar, Huntington Station, NY (US); Eran Halperin, Santa Monica, CA (US)

(21) Appl. No.: 19/003,793

(22) Filed: Dec. 27, 2024

(51) Int. Cl. G06N 3/0895; G06N 3/0455

(52) U.S. Cl. CPC G06N 3/0895; G06N 3/0455

(57) ABSTRACT

Various embodiments of the present disclosure provide a data augmentation technique that improves the functionality of a computer in various aspects. The technique comprises receiving a training dataset, wherein (i) the training dataset comprises a set of datapoints and (ii) a datapoint of the set of datapoints comprises (a) a set of elements and (b) a training label that corresponds to the set of elements and is based on an element-specific label of an element within the set of elements; generating an augmented training dataset from the training dataset by (i) determining, from the set of elements, an element subset, (ii) determining a synthetic training label for the element subset based on the element-specific label, and (iii) generating a synthetic datapoint for the augmented training dataset based on the element subset and the synthetic training label; and training, using the augmented training dataset, the deep set neural network.

### BACKGROUND

Various embodiments of the present disclosure address technical challenges related to machine learning training in sparse feature spaces, such as set-based prediction tasks. Historically, machine learning models have required large amounts of training data to achieve high performance, especially for complex tasks involving variable-sized input sets. This requirement has posed significant obstacles in domains where only a small quantity of datapoints is available, limiting the applicability of traditional machine learning techniques.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram showing example hardware and/or software components for training a deep set neural network in accordance with some embodiments of the present disclosure.

FIG. 5 depicts an operational example of data augmentation in accordance with some embodiments of the present disclosure.

FIG. 6 depicts an operational example of a deep set neural network architecture in accordance with some embodiments of the present disclosure.

FIG. 7 depicts a flowchart diagram of an example process for facilitating training of a deep set neural network in accordance with some embodiments of the present disclosure.

FIG. 8 depicts a flowchart diagram of an example process for generating an augmented training dataset in accordance with some embodiments of the present disclosure.

FIG. 9 depicts a flowchart diagram of an example process 900 for providing inferences using a trained deep set neural network in accordance with some embodiments of the present disclosure.

### DETAILED DESCRIPTION

Various embodiments of the present disclosure provide data augmentation techniques and deep set machine learning model architectures that improve machine learning based prediction tasks by addressing various technical challenges presented by set data. More particularly, some embodiments of the present disclosure provide a data augmentation method that generates an augmented training dataset from a training dataset by generating a synthetic datapoint. The synthetic data point may thereafter serve as an additional datapoint available for training a deep set machine learning model. In this way, some embodiments of the present disclosure may enable training of deep set machine learning models on training datasets that may comprise an insufficient number of datapoints to achieve a desired performance (e.g., in terms of accuracy, generalizability) by expanding the quantity of available training data, as well as providing additional diverse training datapoints to enhance the model training, thereby improving model performance without requiring additional real-world data collection.

Some embodiments of the present disclosure provide a deep set machine learning model that leverages a deep set neural network to generate improved predictions with respect to set data. For example, to overcome deficiencies with traditional classification approaches, a deep set neural network training architecture may be employed to allow a deep set machine learning model to generate predictions on set data. While element-specific labels may be more granular and/or robust, a deep set machine learning model (e.g., comprising a deep set neural network) is suited for learning on training labels that are assigned to an entire datapoint (e.g., comprising a set of element), and thus, traditionally cannot benefit from numerous element-specific labels. In some embodiments, the deep set neural network training architecture may comprise an encoder that is used to transform feature vectors of an input datapoint (e.g. comprising a set of elements) into embedding vectors. Then, some embodiments of the present disclosure aggregate the embedding vectors into an aggregate embedding vector. The aggregate embedding vector may thereafter serve as an information dense representation of the data object that may be used by a decoder to generate improved predictions that generalize to an input dataset (e.g., as opposed to the individual data objects that make up the set). This, in turn, enables improved predictions that, unlike traditional techniques, may handle set data that comprise datapoints comprising variable-sized sets of data elements without reductions in classification accuracy, thereby improving the performance of downstream machine learning-based tasks processing such set data. Accordingly, the data augmentation techniques and deep set machine learning model architectures of the present disclosure provide improved classification and/or prediction of set data over traditional classification models.

To improve the performance of deep set machine learning models, some embodiments of the present disclosure provide a synthetic data generation process for generating an augmented training dataset. The synthetic data generation process may enhance set data classifications and/or predictions by training a deep set neural network on an augmented training dataset. In some embodiments, an augmented training dataset may be generated by determining element subsets from a set of elements in a datapoint, generating synthetic training labels for the element subsets, and generating synthetic datapoints based on the element subsets and their corresponding synthetic training labels. By iteratively applying the aforementioned operations, the augmented training dataset may be expanded to comprise a plurality of synthetic datapoints, significantly increasing the quantity of training data available for training a deep set neural network. As such, the augmented training dataset generation process of the present disclosure addresses several technical challenges associated with training deep set machine learning models that, due to their focus on a set rather than the individual elements with the set, may be associated with a small quantity of datapoints. An augmented training dataset may be generated to increase the diversity and quantity of training data available for training machine learning models, which in turn, may improve model generalization, reduce overfitting, and enhance predictive performance with limited actual data. In addition, or alternatively, augmented training datasets may be used to balance class distributions in imbalanced datasets and/or to simulate rare events or edge cases. Additional/alternative uses of an augmented dataset may further comprise data privacy applications, where synthetic data is used to protect sensitive information, or in transfer learning scenarios where augmented data helps bridge the gap between source and target domains.

Examples of technologically advantageous embodiments of the present disclosure comprise (i) improved training of deep set neural networks on training datasets comprising insufficient datapoints, (ii) a particular data augmentation method that modifies conventional training data to dynamically produce synthetic datapoints for providing additional datapoints and/or increasing a quantity of diverse datapoints in a training dataset, (iii) a deep set machine learning model architecture that provides improved prediction accuracy for set-based machine learning tasks, (iv) a deep set neural network trained in an unconventional fashion to reduce network congestion via receiving lesser-sized training datasets while generating classification and/or prediction outputs with improved accuracy, among other aspects of the present disclosure. Furthermore, the aforementioned improvements enable the application of sophisticated machine learning techniques in domains where data scarcity has previously been a limiting factor, potentially opening up new avenues for predictive modeling and analysis across various fields of computer science and data-driven industries. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

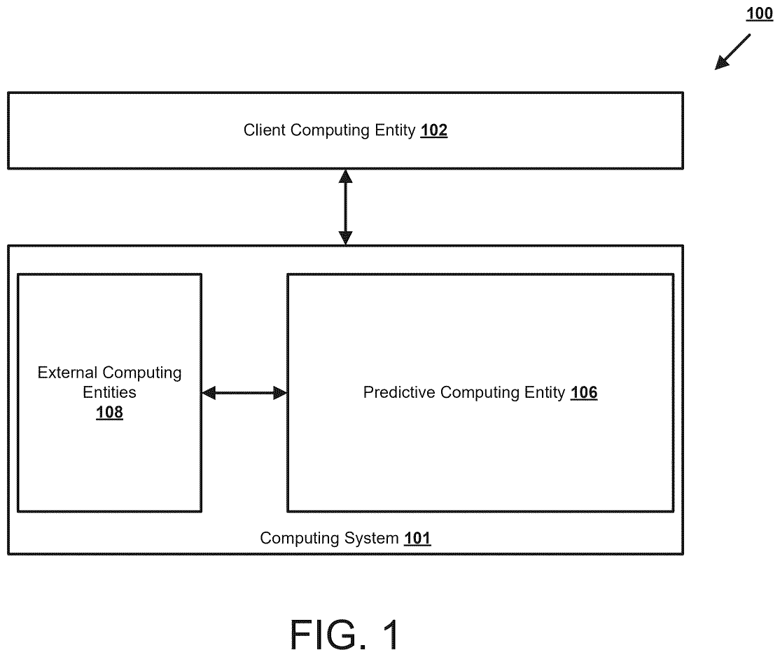

FIG. 1 depicts a block diagram of an example architecture 100 in accordance with some embodiments of the present disclosure. The architecture 100 comprises a computing system 101 configured to receive a request, such as a deep set machine learning model prompt request comprising an input datapoint, and/or the like, from client computing entities 102, process the request to generate a model output (e.g., a classification and/or prediction), and provide the model output to the client computing entities 102. In accordance with various embodiments of the present disclosure, one or more machine learning models may be trained to generate candidate outputs, candidate output scores, and/or other machine learned outputs. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive a request, such as a deep set machine learning model prompt request comprising an input datapoint, and/or the like, from client computing entities 102, process the request to generate a model output (e.g., a classification and/or prediction), and provide the model output to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data augmentation techniques, deep set neural network training and/or inference techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as training datasets, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

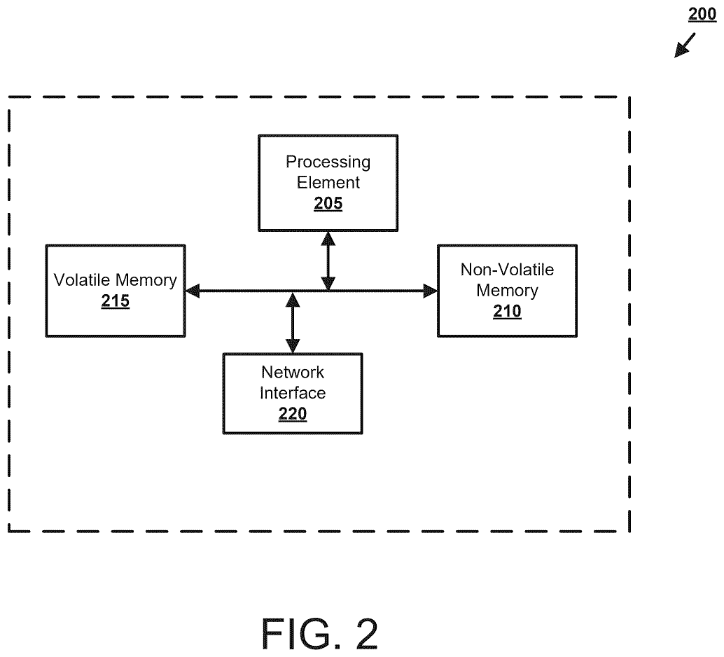

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially greater quantities of information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more components of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

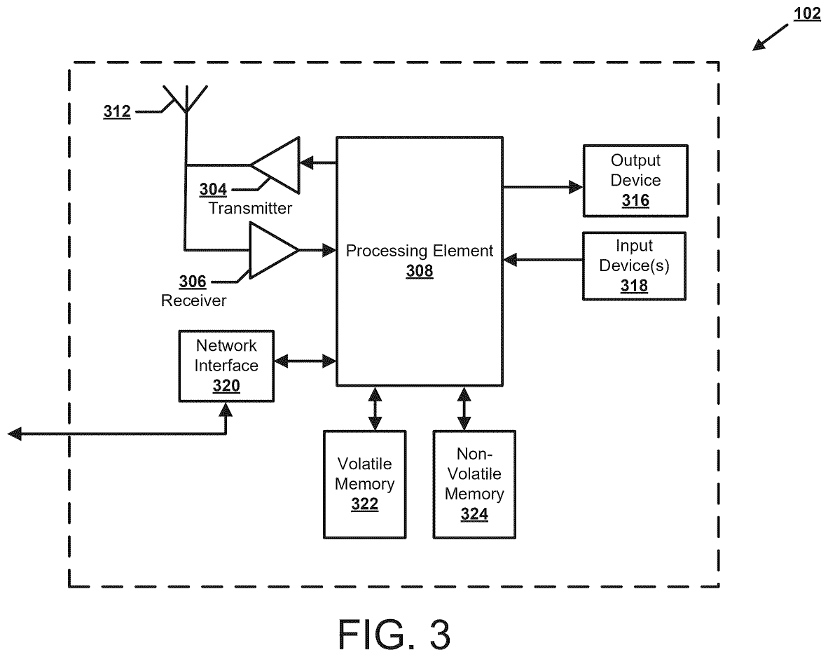

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

Set data may comprise a set of datapoints where at least one of the datapoints may comprise a set of data elements. As indicated, various embodiments of the present disclosure make important technical contributions to machine learning on set data. In particular, systems and methods are disclosed herein that implement data augmentation and machine learning techniques to improve machine learning model training where set data may comprise insufficient or unavailable datapoints as training data by providing additional datapoints and/or increasing a quantity of diverse datapoints to comprise in a training dataset, and thereby providing improved classification/prediction based thereof. This, in turn, may improve the functionality of a computer with respect to various computing tasks, comprising data security, allocating computing resources, machine learning training, network communication, and/or the like.

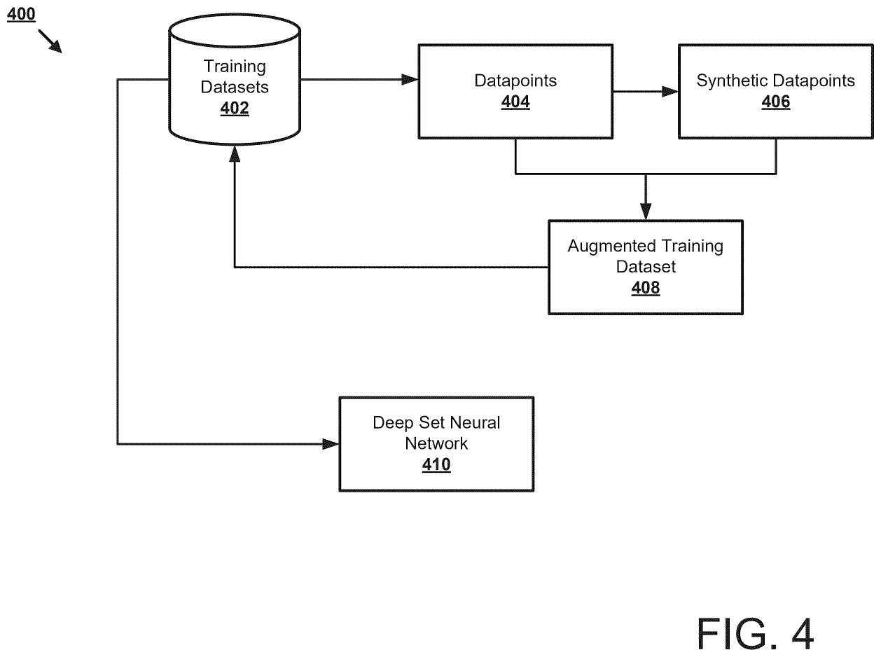

FIG. 4 depicts a dataflow diagram 400 showing example hardware and/or software components for training a deep set neural network 410 in accordance with some embodiments of the present disclosure. The dataflow diagram 400, for example, illustrates a deep set machine learning architecture that is configured to generate an augmented training dataset 408. The augmented training dataset 408 is generated by selectively retrieving datapoints 404 from a database comprising training datasets 402 and generating synthetic datapoints 406 based on the datapoints 404. The augmented training dataset 408 is stored with the database comprising the training datasets 402 for subsequent retrieval by deep set neural network 410. As such, the deep set neural network 410 is configured to train on the augmented training dataset 408. In this way, the deep set machine learning architecture may supplement the training data 402 for training the deep set neural network 410 in situations where a quantity of datapoints 404 may be insufficient.

In some embodiments, a training dataset (e.g., from training datasets 402) is received for a deep set neural network 410. The training dataset may comprise a set of datapoints (e.g., datapoints 404). A datapoint of the set of datapoints may comprise (a) a set of elements and (b) a training label that corresponds to the set of elements and is based on an element-specific label of an element within the set of elements. For example, the set of datapoints comprises a set of feature vectors that are labeled with a set of respectively corresponding training labels.

In some embodiments, a dataset describes a collection of datapoints used for analysis and/or training machine learning algorithms. A dataset may comprise a structured set of data that is stored in a computer-readable format, such as a database, spreadsheet, file system, and/or the like. The dataset may be implemented as a relational database with rows representing individual datapoints and columns representing data features and/or attributes. Alternatively, a dataset may be stored as a NoSQL database, graph database, distributed file system, and/or the like to handle large-scale and/or unstructured data. Accordingly, dataset may provide a standardized format for storing and accessing data, enabling efficient querying and retrieval of information. In addition, or alternatively, a dataset may be preprocessed, cleaned, and/or transformed to prepare data in the dataset for specific analytical techniques, such as data analytics, statistical analysis, and/or machine learning tasks. In the context of machine learning, datasets may be split into training, validation, and test sets to develop and evaluate models.

In some embodiments, a training dataset describes a specific dataset that is used to train a machine learning model. For example, a training dataset may comprise a collection of input-output pairs (e.g., datapoints and respectively corresponding training labels) that are used to teach a machine learning algorithm to recognize patterns and make predictions. A training dataset may be stored in computer memory as an array, object, and/or database record. A training dataset may be used to provide examples from which a machine learning model may learn from. In particular, input datapoints of a training dataset may be provided to a machine learning model to generate predictions that are compared with labels from the training dataset that respectively correspond to the input datapoints, and based on the comparison, the machine learning model's parameters may be adjusted to minimize the difference between predictions generated by the machine learning model and the labels from the training dataset.

In some embodiments, a datapoint describes a discrete unit of data within a dataset. A datapoint may comprise a group of data elements that is singularly enumerated within a dataset. Datapoints may be processed by various data analysis and machine learning algorithms. The functionality of a datapoint comprises encapsulating related information (e.g., elements) about a single entity and/or observation. That is, a datapoint may comprise and/or be representative of a set of elements that are grouped and/or clustered based on specific criteria. For example, a dataset may comprise a set of patients that have been treated over a year and a datapoint from the dataset may comprise a subset of the patients that have been treated in a specific month of the year, and hence the dataset may comprise 12 datapoints—one for each month. A datapoint may be implemented as a row in a database table, an object in an object-oriented programming language, a vector in a mathematical representation (e.g., a matrix), and/or the like. For example, a dataset may comprise a plurality of datapoints comprising health and/or medical data (e.g., electronic medical record (EMR) and/or electronic health record (EHR)) that are associated with a patient population over a period of time (e.g., four years). One or more of these datapoints may comprise a portion of the dataset comprising data of the patient population over a sample portion (e.g., a month) of the period of time. Moreover, a datapoint may comprise a plurality of elements that belong to the datapoint, such as data associated with individual patients.

In some embodiments, an element describes a portion of a datapoint. For example, an element may represent a single data instance representative of an attribute, factor, feature, constituent, and/or measurement that contributes to an overall composition of a datapoint. An element may be implemented as a field in a database record that is associated with a datapoint, and/or as a single value in an array or vector. An element may comprise numerical data, categorical data, time series data, text data, image data, and/or audio data. The functionality of an element may comprise providing granular information about specific aspects of a datapoint, enabling detailed analysis and comparison across different instances. Elements may be used by various data manipulation and analysis functions, such as data feature selection algorithms, data feature encoding/embedding algorithms, dimensionality reduction techniques, and/or synthetic data generation. An element may be stored in memory using a primitive data type (e.g., integers, floats, and/or strings) or more complex data structures depending on the nature of the data. In some embodiments, elements may serve as inputs for individual neurons in a neural network, such as a deep set neural network. That is, a datapoint may comprise a plurality of elements that may be provided as input to a neural network in the form of a plurality of respectively corresponding feature vectors. For example, an element may be representative of a patient and a feature vector of the element may encode predictive features of the patient.

In some embodiments, a training label describes an identifier of a classification assigned to a datapoint and/or a set of elements within a training dataset. In addition, or alternatively, a training label may represent a target variable and/or outcome that a machine learning model is trained to predict. Training labels may be implemented as categorical variables (e.g., strings and/or integers representing classes), continuous variables (e.g., floating-point numbers for regression tasks), binary variables, and/or the like. Training labels may be used in supervised learning algorithms to guide the learning process (e.g., training) of a machine learning model. Training labels may be stored alongside input data features (e.g., datapoints) in a training dataset and be used to provide the “ground truth” for a machine learning model to learn from. For example, training a machine learning model may comprise using a loss function to measure a difference between predicted labels (e.g., prediction outputs generated by the machine learning model) and actual labels (e.g., training labels) during model training such that the machine learning model may adjust its parameters to minimize prediction errors.

The performance of a machine learning model may vary and/or depend on the number of training examples that are used to train the machine learning model, and as such, a greater quantity of training examples may result in better model performance. In deep set machine learning model training (e.g., training of a machine learning model comprising a deep set neural network), a single training label may be assigned to a dataset comprising a plurality of elements thereby resulting in a single training example, which may lead to less training examples being available to train a deep set neural network and lower model performance.

In some embodiments, an element-specific label describes an identifier of a classification assigned to an individual element within a datapoint. In addition, or alternatively, an element-specific label may represent a characteristic and/or category associated with a particular element of a datapoint. Element-specific labels may be implemented as metadata associated with individual fields in a database and/or as annotations in a data structure. An element-specific label may be processed by data feature engineering algorithms, data feature encoding/embedding algorithms, data preprocessing pipelines, and/or specialized machine learning models that operate on individual elements rather than entire datapoints. Element-specific labels may provide fine-grained classification information at the element level, enabling more detailed analysis, feature extraction, encoding/embedding, and/or modeling. In some embodiments, a training dataset may comprise training labels that are based on element-specific labels and used in supervised learning algorithms to guide a learning process (e.g., training) of a machine learning model. For example, an element-specific label (e.g., associated with an element) may comprise a disease marker that is assigned to an individual patient and may be used as a training label to train a machine learning model to predict the prevalence of a disease. While element-specific labels may be more granular and/or robust, a deep set machine learning model (e.g., comprising a deep set neural network) is suited for learning on training labels that are assigned to an entire datapoint (e.g., comprising a set of element), and thus, traditionally cannot benefit from numerous element-specific labels.

In some embodiments, a deep set neural network describes an artificial neural network comprising a plurality of hidden layers that are used in a machine learning algorithm configured to generate a prediction for a datapoint comprising a set of elements. A deep set neural network may extend traditional neural network architectures to handle datapoints that are provided as sets of data elements. As such, deep set neural networks may be processed using training algorithms that are configured to process datapoints comprising a set structure (e.g., sets of data elements). Deep set neural networks may be implemented using various neural network layers, comprising fully connected layers, convolutional layers, attention layers, feed-forward layers, and/or specialized set pooling layers. The functionality of a deep set neural network may comprise learning representations and making predictions on set-structured datapoints.

A deep set neural network may be trained with supervised and/or self-supervised training techniques to predict outcomes based on a learned relationship between data features (e.g., one or more feature vectors) of datapoints and respectively corresponding training labels provided as training examples from training datasets. As such, a machine learning algorithm may train a deep set neural network to predict outcomes on new, unseen datapoints by generalizing from training datasets. For example, a deep set neural network may be trained to predict the prevalence of a disease by learning from a training dataset comprising patient population health data over a period of time (e.g., a four-year duration). The training dataset may comprise a plurality of datapoints where one or more subsets of the period of time (e.g., months) may be represented by a datapoint, and one or more datapoints may comprise a set of elements, and one or more elements may comprise data that is representative of a patient or patient feature (e.g., demographics, claims data, etc.). The training dataset may further comprise, for one or more of the elements, an element-specific label that provides a disease class.

Training a deep set neural network may comprise forward propagation that calculates a predicted output of the deep set neural network for a training datapoint based on current values of weights and/or biases. The predicted output may be compared to a respectively corresponding training label to calculate a loss, which may be used to update the weights and biases during the training process. That is, a loss function may be used during the training of a deep set neural network to guide the learning process (e.g., adjusting model parameters, such as weights and/or biases) by minimizing error (e.g., such that predicted outputs are as close as possible to training labels in the training dataset).

In addition, or alternatively, training a deep set neural network may comprise back-propagation of errors that enable computation of gradients for optimizing (e.g., via improvement in model performance) model parameters. A loss function may be used to quantify a difference between a predicted output and a respectively corresponding training label. Backpropagation may comprise applying the chain rule of calculus to determine a gradient of the loss function with respect to the weights of the deep set neural network to propagate an error backward through the deep set neural network, layer by layer. The gradient may be used in an optimization algorithm, such as stochastic gradient descent and/or adaptive moment estimation (Adam) to minimize errors. A deep set neural network may comprise any neural architecture, such as a CNN, a feedforward neural network, a RNN, a long short-term memory (LSTM) network, a generative adversarial network (GAN), a modular neural network, a transformer neural network, and/or the like.

In some embodiments, a feature vector describes a numerical representation of an element of a datapoint. A feature vector may encode relevant characteristics and/or attributes of an instance into a fixed-length array of numerical values. Feature vectors may be implemented as arrays, tensors, and/or specialized data structures optimized for numerical computations. Feature vectors may be processed by various machine learning algorithms, such as neural networks (e.g., convolutional neural networks (CNN), recurrent neural networks (RNN), and/or the like), support vector machines, and clustering algorithms. A feature vector may be used to represent complex data in a format that may be suitably processed by machine learning models. For example, feature vectors may enable the transformation of raw data (e.g., an element of a datapoint) into a structured format suitable for mathematical operations and pattern recognition associated with a machine learning algorithm. In addition, or alternatively, feature vectors may be used for tasks, such as similarity comparisons, dimensionality reduction, and/or as inputs to machine learning classification models. Alternative or additional uses of a feature vector may comprise data compression, where feature vectors provide a compact representation of high-dimensional data, and/or in transfer learning, where pre-trained feature extractors generate feature vectors that may be used across different tasks and/or domains.

In some embodiments, an augmented training dataset describes a training dataset for a deep set machine learning model that has been modified to comprise synthetic datapoints. An augmented training dataset may comprise an expansion, enhancement, and/or improvement of an original training dataset by incorporating artificially generated and/or modified data via synthetic datapoints and synthetic training labels. An augmented training dataset may be generated to increase the diversity and quantity of training data available for training machine learning models, which in turn, may improve model generalization, reduce overfitting, and enhance predictive performance with limited actual data. In addition, or alternatively, augmented training datasets may be used to balance class distributions in imbalanced datasets and/or to simulate rare events or edge cases. Additional/alternative uses of an augmented dataset may further comprise data privacy applications, where synthetic data is used to protect sensitive information, or in transfer learning scenarios where augmented data helps bridge the gap between source and target domains.

In some embodiments, a synthetic datapoint describes a discrete unit of data within an augmented training dataset that is artificially generated based on an element subset of a set of elements from a training dataset. A synthetic datapoint may represent a novel, artificially created instance that mimics the structure and characteristics of real datapoints. Synthetic datapoints may be implemented using the same data structures as real datapoints, such as database rows, objects, vectors, and/or the like, but are generated through algorithmic means. Synthetic datapoints may be generated to augment existing datasets to provide additional training examples for machine learning models. In addition, or alternatively, synthetic datapoints may help address issues, such as data scarcity, class imbalance, and/or limited coverage of the feature space. Synthetic datapoints may be used to improve model robustness, explore edge cases, and/or simulate scenarios that are rare and/or difficult to observe in real data. Additional/alternative uses of synthetic datapoints may further comprise data anonymization, where synthetic datapoints replace sensitive real data, and/or in simulation environments where synthetic data is used to test system behavior under various conditions.

In some embodiments, a synthetic training label describes an identifier of a classification assigned to a synthetic datapoint within an augmented training dataset. For example, a synthetic training label may be generated alongside a corresponding synthetic datapoint and is integrated into an augmented training dataset. A synthetic training label may represent a predicted and/or artificially generated target variable that a machine learning model is trained to predict. Synthetic training labels may be implemented similarly to non-synthetic training labels, using categorical or continuous variables, but may be generated through algorithmic means rather than being derived from real-world observations. Synthetic training labels may be created using various techniques such as rule-based systems, statistical modeling, and/or machine learning algorithms trained on an original training dataset. As such, synthetic training labels may provide target values for artificially generated datapoints, thereby enabling the expansion of training datasets while maintaining a supervised learning paradigm. For example, synthetic training labels may be used to increase the diversity of training examples, simulate rare classes or outcomes, and/or explore hypothetical scenarios.

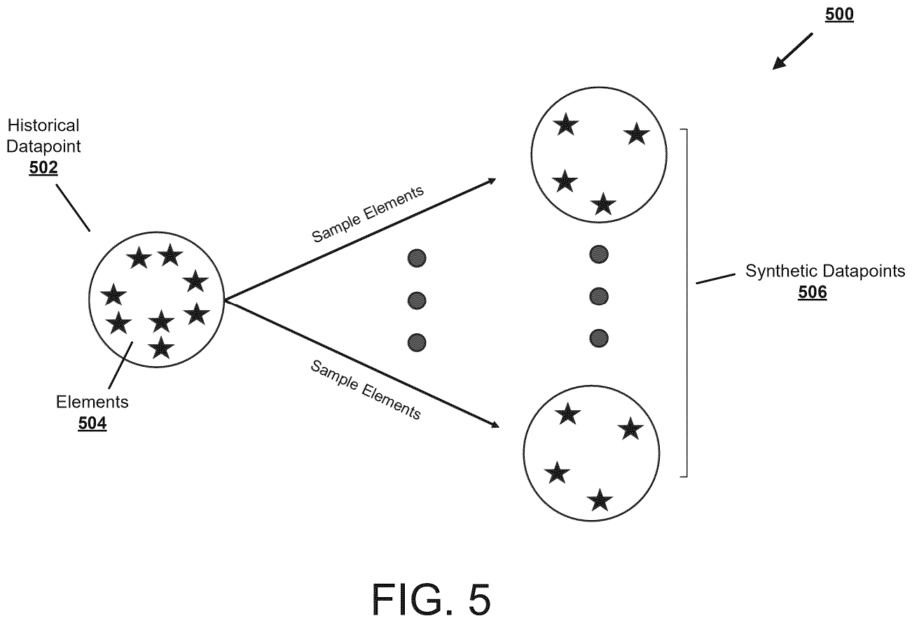

FIG. 5 depicts an operational example 500 of data augmentation in accordance with some embodiments of the present disclosure. As shown in the operational example 500, a historical datapoint 502 comprises a plurality of elements 504. The historical datapoint 502 may comprise a datapoint of a plurality of datapoints from a training dataset. Synthetic datapoints 506 are generated by sampling from the elements 504 into respectively corresponding element subsets. In this way, the synthetic datapoints 506 may enable training of deep set machine learning models on training datasets comprising insufficient datapoints by expanding the quantity of available training data, as well as providing additional diverse training datapoints to enhance the model training, thereby improving model performance without requiring additional real-world data collection.

In some embodiments, an element subset that comprises an element is determined from a set of elements (e.g., elements 504). In some embodiments, a synthetic training label is determined for the element subset based on an element-specific label. In some embodiments, a synthetic datapoint (e.g., synthetic datapoints 506) is generated for an augmented training dataset based on the element subset and the synthetic training label. For example, a plurality of synthetic datapoints may be generated by iteratively determining, from the set of elements, a plurality of element subsets. In another example, the plurality of synthetic datapoints may be generated based on an iteration threshold.

In some embodiments, the iteration threshold may be associated with a performance of a deep set machine learning model trained that is iteratively trained on the augmented training dataset. For example, after one or more iterations of generating synthetic datapoints, a deep set machine learning model may be trained on the generated synthetic datapoints and evaluated based on one or more performance metrics, such as precision, recall, accuracy, confusion matrix, F1 score, area under the receiver operating characteristic curve (AUC-ROC), and/or cross-validation, among others. Based on the performance of the trained deep set machine learning model, additional iterations of generating synthetic datapoint may be performed if the one or more performance metrics does not satisfy the iteration threshold, otherwise, additional synthetic datapoints may not be generated.

In addition, or alternatively, determining the element subset may further comprise (a) determining the element subset from a target subset of the set of elements that is associated with a target data feature, (b) determining a sample size for the element subset, wherein the sample size is based on the target data feature, and/or (c) determining the element subset from the set of elements based on a temporal sequence of the set of elements.

In some embodiments, an iteration threshold describes a value that is used to determine a number of iterations to sample from a set of elements of a training dataset to generate synthetic datapoints. An iteration threshold may represent a stopping criterion and/or limit for an iterative training dataset augmentation process. For example, an iteration threshold may be used in control structures, such as loops and/or recursive functions, that govern the generation of synthetic datapoints in a training dataset augmentation process. An iteration threshold may be used to control the extent of training dataset augmentation, balancing the benefits of increased dataset size with computational costs and the risk of introducing too much synthetic datapoints. Iteration thresholds may be used to ensure a desired ratio of actual datapoints to synthetic datapoints, so as to limit the total size of an augmented training dataset, and/or to implement early stopping criteria based on model performance.

In some embodiments, a target data feature describes a specific data feature that may be used as a criterion for sampling elements from a set of elements of a datapoint from a training dataset to generate synthetic datapoints. A target data feature may represent a particular attribute and/or characteristic of an element that is of interest for an element sampling process (from a set of elements). Target data features may be processed by sampling algorithms, stratification methods, and/or data augmentation techniques that aim to preserve and/or modify specific characteristics of a datapoint. A target data feature may be used to guide a training dataset augmentation process to focus on specific aspects of a datapoint in the training dataset that may be particularly relevant and/or challenging for a machine learning task. Target data features may be used for tasks, such as balanced sampling to address class imbalance, targeted augmentation of underrepresented subgroups, and/or generation of synthetic examples that vary along specific dimensions of interest.

In some embodiments, a temporal sequence describes a time-series order that may be associated with a set of elements of a datapoint. For example, a set of elements from a historical datapoint (e.g., historical datapoint 502) of a training dataset may correspond to a set of historical timepoints. A temporal sequence may represent an arrangement of elements that are ordered based on occurrence in time. A temporal sequence may capture and represent the evolution of data and/or events over time, enabling analysis of trends, patterns, and dependencies that incorporate temporal information.

In some embodiments, a historical timepoint describes an instance of time that is prior to a timepoint of when an input datapoint is received. A historical timepoint may represent a specific moment and/or period in the past for which data (e.g., datapoints) is available and relevant to a current analysis and/or prediction task. Historical timepoints may be used for prediction tasks, such as time series forecasting and/or anomaly detection in temporal data, and/or as features in predictive models that leverage historical information. For example, historical timepoints may be processed by time series analysis algorithms, forecasting models, and/or machine learning systems that incorporate temporal information. Accordingly, historical timepoints may provide temporal context for data analysis, enabling the study of trends, patterns, and/or changes over time.

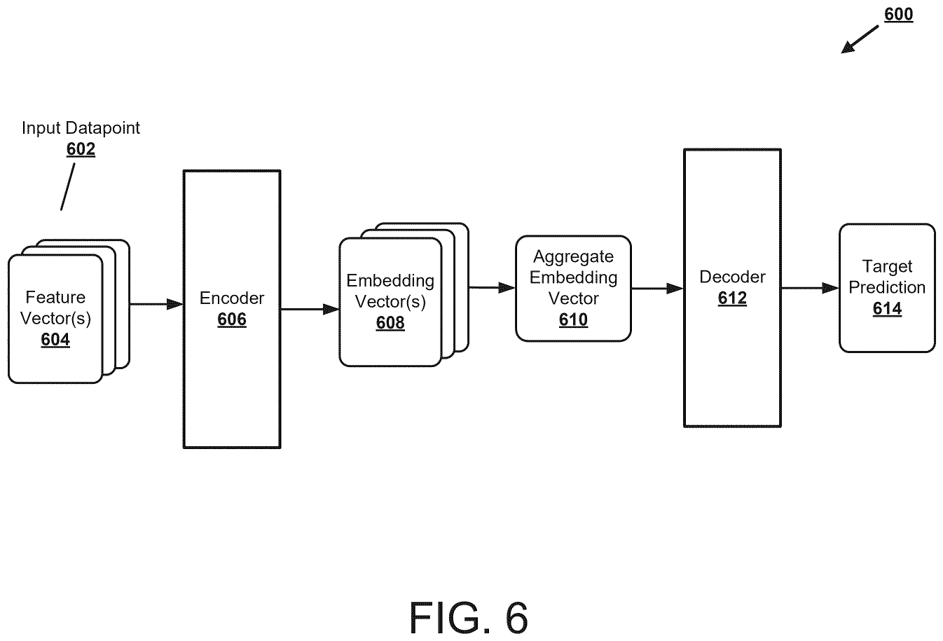

FIG. 6 depicts an operational example 600 of a deep set neural network architecture in accordance with some embodiments of the present disclosure. As shown in the operational example 600, an input datapoint 602 comprises one or more feature vectors 604. The deep set neural network architecture is configured to provide the one or more feature vectors 604 to an encoder 606. The encoder 606 is configured to generate one or more embedding vectors 608 based on (e.g., that respectively correspond to) the one or more feature vectors 604. The deep set neural network architecture is further configured to generate an aggregate embedding vector 610 based on the embedding vectors 608 and provide the aggregate embedding vector 610 to a decoder 612. The decoder 612 is configured to generate a target prediction 614 based on the aggregate embedding vector 610. By doing so, the target prediction 614 may be generated by the decoder 612 in a manner that captures data features (e.g., via the one or more feature vectors 604) that are associated with up to each element associated with the input datapoint 602.

In some embodiments, a set of datapoints from a training dataset respectively corresponds to a set of historical timepoints. In some embodiments, an input datapoint (e.g., input datapoint 602) that corresponds to a timepoint subsequent to a set of historical timepoints is received. In some embodiments, using an encoder (e.g., encoder 606) of a deep set neural network, a set of embedding vectors (e.g., embedding vectors 608) is generated based on a set of input feature vectors (e.g., feature vectors 604) of the input datapoint. In some embodiments, an aggregate embedding vector (e.g., aggregate embedding vector 610) is generated based on the set of embedding vectors. In some embodiments, using a decoder (e.g., decoder 612) of the deep set neural network, a target prediction (e.g., target prediction 614) is outputted based on the aggregate embedding vector.

In some embodiments, an input datapoint describes a datapoint that is provided as an inference input to an encoder of an encoder-decoder architecture comprising a neural network, such as a deep set neural network. An input datapoint may represent a new, unseen instance that a trained machine learning model is asked to process and/or make predictions about. Input datapoints may be implemented using the same data structures as training datapoints but specifically designated for inference rather than training. An input datapoint may be processed by an encoder that transforms raw data of the input datapoint into one or more feature vectors. An input datapoint may serve as a basis for generating predictions and/or extracting insights using a trained machine learning model. As such, input datapoints may enable the application of learned patterns to new, unseen data. For example, input datapoints may be provided for tasks such as classification, prediction, regression, and/or generating embeddings for downstream tasks.

In some embodiments, an embedding vector describes a numerical representation of an input feature vector associated with an element of a datapoint. An embedding vector may represent a low-dimensional representation of high-dimensional and/or complex input data (e.g., datapoints). Embedding vectors may be implemented as dense arrays, tensors, and/or the like, that are optimized for efficient computation and storage. An embedding vector may be generated by an encoder of an encoder-decoder architecture comprising a neural network, such as a deep set neural network. An embedding vector may be used to capture semantic and/or structural information about data (e.g., an element of a datapoint) in a compact, continuous vector space. Embedding vectors may enable dimensionality reduction, facilitate similarity comparisons, and serve as learned feature representations for downstream tasks (e.g., decoding and/or prediction) and/or as inputs to subsequent layers (e.g., for generating an aggregate embedding vector) of a neural network in deep learning models.

In some embodiments, an aggregate embedding vector describes a single vector that is representative of a datapoint. The aggregate embedding vector, for example, may comprise a combination of a plurality of embedding vectors. An aggregate embedding vector may summarize and/or combine information from a plurality of individual embeddings into a fixed-size representation. Aggregate embedding vectors may be implemented as dense arrays, tensors, and/or the like, similar to individual embedding vectors, but derived through operations that combine a plurality of vectors. For example, an aggregate embedding vector may be generated through various pooling and/or aggregation operations, such as element-wise mean, max, or sum, or more complex operations like attention mechanisms. The aggregation operations may be implemented as part of a neural network architecture, for example, in specialized layers designed for set-based and/or sequence-based inputs. An aggregate embedding vector may provide a fixed-size representation for variable-sized inputs, such as sets and/or sequences of elements. As such, the processing of inputs with different numbers of elements may be enabled by subsequent fixed-size neural network layers. An aggregate embedding vector may be used for performing tasks, such as set data classification and/or multi-instance learning.

In some embodiments, an encoder describes an input-receiving portion of a machine learning model comprising an encoder-decoder architecture. An encoder may transform input data (e.g., a datapoint and/or one or more elements of the datapoint) into a latent representation, such as a vector embedding that captures essential features of the input data. An encoder may be implemented as part of a forward pass in neural network training and inference. For example, an encoder may be implemented within a series of neural network layers followed by pooling and/or aggregation operations (e.g., to generate an aggregate embedding vector). An encoder may be used for dimensionality reduction and/or feature extraction. That is, an encoder may be configured to learn a compact, informative representation of input data that may be used for various downstream tasks (e.g., decoding and/or prediction) and/or as input to subsequent layers (e.g., for generating an aggregate embedding vector) of a neural network, such as a deep set neural network, in deep learning models.

In some embodiments, a decoder describes an output-generating portion of a machine learning model comprising an encoder-decoder architecture. A decoder may transform a latent representation and/or embedding (e.g., an embedding vector or an aggregated embedding vector) into a provided input space or into a desired output format. In other words, a decoder may enable a machine learning model to learn a mapping from a latent space back to an original data space or to a target output space. For example, a decoder may be configured to generate an output based on a latent representation and/or embedding generated by an encoder of input data (e.g., a datapoint and/or one or more elements of the datapoint). Additionally, a decoder may be implemented to mirror a structure of an encoder in reverse. A decoder may be implemented as part of a forward pass in neural network training and inference, and may follow an encoder. For example, a decoder may be implemented within a series of neural network layers of a neural network, such as a deep set neural network, following encoding/embedding operation layers.

In some embodiments, a target prediction describes an output that is generated by a decoder of an encoder-decoder architecture comprising a neural network, such as a deep set neural network. A target prediction may represent a machine learning model's estimate and/or forecast for a specific task (e.g., classification and/or prediction) based on input data (e.g., a datapoint and/or one or more elements of the datapoint). A target prediction may be expressed as numerical data, categorical data, time series data, text data, image data, and/or audio data depending on the nature of the prediction task. Target predictions may be generated through a forward pass of a neural network, specifically by a decoder operating on a latent representation and/or embedding generated by an encoder. For example, a deep set neural network may be trained to generate a target prediction comprising a disease prevalence prediction based on a datapoint comprising patient population health data for a given month.

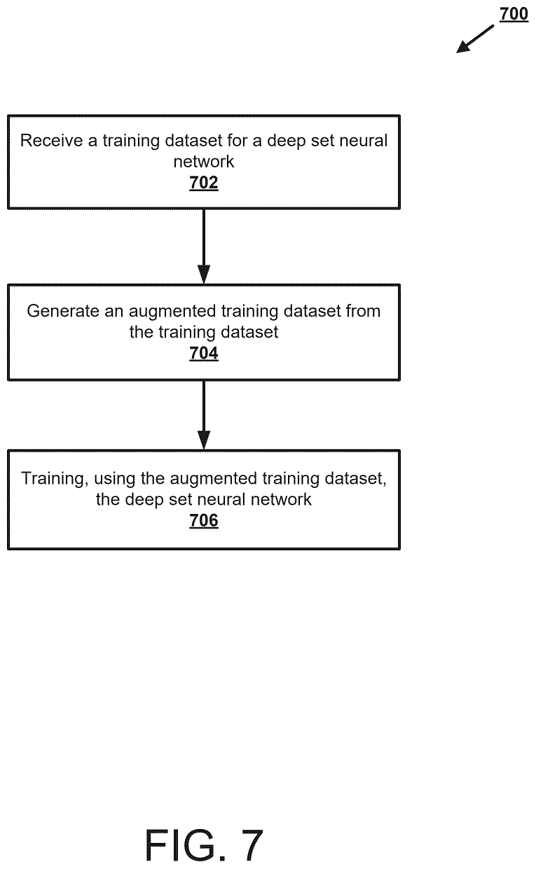

FIG. 7 depicts a flowchart diagram of an example process 700 for facilitating training of a deep set neural network in accordance with some embodiments of the present disclosure. The flowchart diagram depicts an example training data preparation process 700 for mitigating training a deep set neural network with a training dataset that may comprise insufficient datapoints. The process 700 may be implemented by one or more computing devices, entities, and/or systems described herein. For example, via the various steps/operations of the process 700, the computing system 101 may leverage a data augmentation technique to supplement a training dataset that may be inadequate for training a deep set neural network, such as deep set neural network 410, by generating an augmented training dataset, such as augmented training dataset 408. By doing so, the process 700 improves computer functionality by improving the quality of a training dataset with respect to quantity and/or diversity of datapoints. This, in turn, allows for improved machine learning performance by mitigating insufficient datapoints in training datasets that limit traditional machine learning model training.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving a training dataset for a deep set neural network. For example, the computing system 101 may receive a training dataset for a deep set neural network. In some embodiments, the training dataset comprises a set of datapoints. In some embodiments, a datapoint of the set of datapoints comprises (a) a set of elements and (b) a training label that corresponds to the set of elements and is based on an element-specific label of an element within the set of elements.

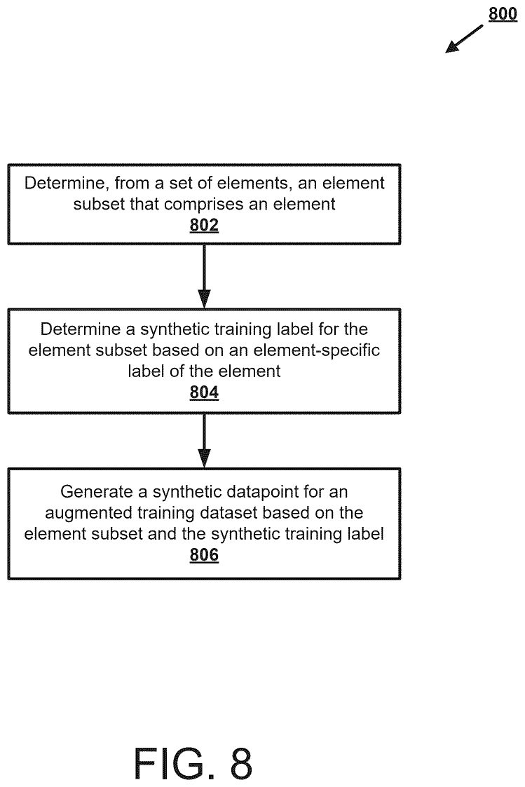

In some embodiments, the process 700 comprises, at operation 704, generating an augmented training dataset from the training dataset. For example, the computing system 101 may generate an augmented training dataset from the training dataset. An example of an augmented training dataset generation process is discussed in further detail with reference to FIG. 8.

In some embodiments, the process 700 comprises, at operation 706, training, using the augmented training dataset, the deep set neural network. For example, the computing system 101 may train, using the augmented training dataset, the deep set neural network.

FIG. 8 depicts a flowchart diagram of an example process 800 for generating an augmented training dataset in accordance with some embodiments of the present disclosure. The flowchart diagram depicts an example data augmentation process 800 for mitigating the shortcomings of training machine leaning models on training datasets comprising insufficient quantities of datapoints. The process 800 may be implemented by one or more computing devices, entities, and/or systems described herein. For example, via the various steps/operations of the process 800, the computing system 101 may generate synthetic datapoints by sampling elements from a set of elements that is associated with a datapoint from a training dataset. By doing so, the process 800 improves computer functionality by improving machine learning training and, in turn, machine learning performance by mitigating training with insufficient quantities of datapoints that traditionally limits machine learning.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, determining, from a set of elements, an element subset that comprises an element. For example, the computing system 101 may determine, from a set of elements, an element subset that comprises an element.

In some embodiments, the process 800 comprises, at operation 804, determining a synthetic training label for the element subset based on an element-specific label. For example, the computing system 101 may determine a synthetic training label for the element subset based on an element-specific label.

In some embodiments, the process 800 comprises, at operation 806, generating a synthetic datapoint for an augmented training dataset based on the element subset and the synthetic training label. For example, the computing system 101 may generate a synthetic datapoint for the augmented training dataset based on the element subset and the synthetic training label.

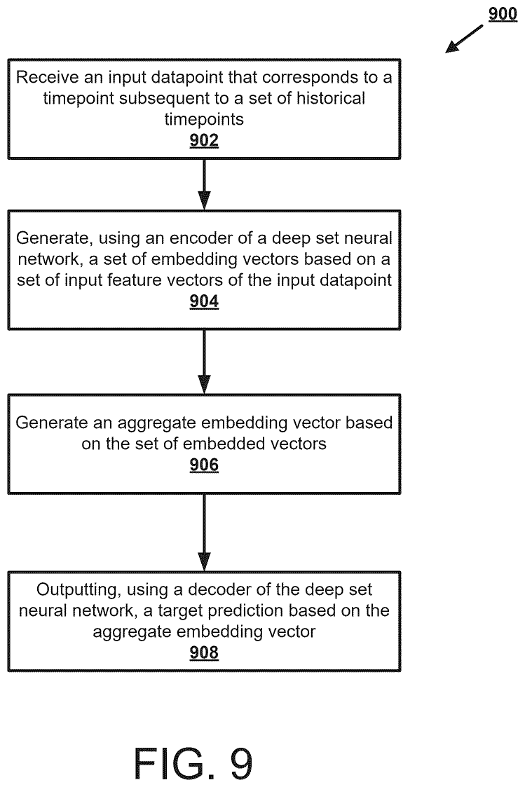

FIG. 9 depicts a flowchart diagram of an example process 900 for providing inferences using a trained deep set neural network in accordance with some embodiments of the present disclosure. The flowchart diagram depicts an inference process 900 for overcoming performance deficiencies of machine learning models processing datapoints comprising set data. The process 900 may be implemented by one or more computing devices, entities, and/or systems described herein. For example, via the various steps/operations of the process 900, the computing system 101 may leverage a deep set neural network architecture to generate a set of embedding vectors for a set of input feature vectors of an input datapoint, aggregate the embedding vectors into a single aggregate embedding vector, and generate a target prediction based on the aggregate embedding vector. By doing so, the process 900 facilitates a data feature engineering technique to improve data feature extraction of datapoints from a dataset where at least one of the datapoints further comprise a set of elements that may individually be represented by a respectively corresponding feature vector. This, in turn, allows for improved machine learning performance by capturing granular data features associated with up to each datapoint of a dataset, which traditional machine learning model techniques do not support.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, receiving an input datapoint that corresponds to a timepoint subsequent to a set of historical timepoints. For example, the computing system 101 may receive an input datapoint that corresponds to a timepoint subsequent to a set of historical timepoints.

In some embodiments, the process 900 comprises, at operation 904, generating, using an encoder of a deep set neural network, a set of embedding vectors based on a set of input feature vectors of the input datapoint. For example, the computing system 101 may generate, using an encoder of a deep set neural network, a set of embedding vectors based on a set of input feature vectors of the input datapoint.

In some embodiments, the process 900 comprises, at operation 906, generating an aggregate embedding vector based on the set of embedding vectors. For example, the computing system 101 may generate an aggregate embedding vector based on the set of embedding vectors.

In some embodiments, the process 900 comprises, at operation 908, outputting, using a decoder of the deep set neural network, a target prediction based on the aggregate embedding vector. For example, the computing system 101 may output, using a decoder of the deep set neural network, a target prediction based on the aggregate embedding vector.

Some techniques of the present disclosure enable the generation of action outputs that may be performed to initiate one or more real world actions to achieve real-world effects. The techniques of the present disclosure may be used, applied, and/or otherwise leveraged to perform a resource-based action (e.g., allocation of resource), generate a diagnostic report, generating and/or executing action scripts, generate alerts or messages, generate one or more electronic communications, and/or display visual renderings of the aforementioned examples of action outputs in addition to values, charts, and representations using a prediction output user interface.

In some examples, the target predictions of the present disclosure may trigger action outputs (e.g., through control instructions) to automate computer performance actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

### Example 1

A computer-implemented method comprising: receiving, by one or more processors, a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements; generating, by the one or more processors, an augmented training dataset from the training dataset by: determining, from the set of elements, an element subset that comprises the element, determining a synthetic training label for the element subset based on the element-specific label, and generating a synthetic datapoint for the augmented training dataset based on the element subset and the synthetic training label; and training, by the one or more processors and using the augmented training dataset, the deep set neural network.

### Example 2

The computer-implemented method of example 1, wherein the set of datapoints comprises a set of feature vectors that are labeled with a set of respectively corresponding training labels.

### Example 3

The computer-implemented method of example 1, wherein the set of datapoints respectively corresponds to a set of historical timepoints and the computer-implemented method further comprises: receiving an input datapoint that corresponds to a timepoint subsequent to the set of historical timepoints; generating, using an encoder of the deep set neural network, a set of embedding vectors based on a set of input feature vectors of the input datapoint; generating an aggregate embedding vector based on the set of embedding vectors; and outputting, using a decoder of the deep set neural network, a target prediction based on the aggregate embedding vector.

### Example 4

The computer-implemented method of example 1 further comprising generating a plurality of synthetic datapoints by iteratively determining, from the set of elements, a plurality of element subsets.

### Example 5

The computer-implemented method of example 4 further comprising generating the plurality of synthetic datapoints based on an iteration threshold.

### Example 6

The computer-implemented method of example 1, wherein determining the element subset is based on a target subset of the set of elements that is associated with a target data feature.

### Example 7

The computer-implemented method of example 6, wherein determining the element subset further comprises determining a sample size for the element subset, wherein the sample size is based on the target data feature.

### Example 8

The computer-implemented method of example 1, wherein determining the element subset is based on a temporal sequence of the set of elements.

### Example 9

A system comprising one or more processors and at least one memory storing processor-executable instructions that, when executed by any of the one or more processors, causes the one or more processors to perform operations comprising: receiving a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements; generating an augmented training dataset from the training dataset by: determining, from the set of elements, an element subset that comprises the element, determining a synthetic training label for the element subset based on the element-specific label, and generating a synthetic datapoint for the augmented training dataset based on the element subset and the synthetic training label; and training, using the augmented training dataset, the deep set neural network.
Example 10

The system of example 9, wherein the set of datapoints respectively corresponds to a set of historical timepoints and the operations further comprise: receiving an input datapoint that corresponds to a timepoint subsequent to the set of historical timepoints; generating, using an encoder of the deep set neural network, a set of embedding vectors based on a set of input feature vectors of the input datapoint; generating an aggregate embedding vector based on the set of embedding vectors; and outputting, using a decoder of the deep set neural network, a target prediction based on the aggregate embedding vector.
Example 11

The system of example 9, wherein the operations further comprise generating a plurality of synthetic datapoints by iteratively determining, from the set of elements, a plurality of element subsets.
Example 12

The system of example 11, wherein the operations further comprise generating the plurality of synthetic datapoints based on an iteration threshold.
Example 13

The system of example 9, wherein determining the element subset is based on a target subset of the set of elements that is associated with a target data feature.
Example 14

The system of example 13, wherein to determine the element subset, the operations further comprise determining a sample size for the element subset, wherein the sample size is based on the target data feature.
Example 15

The system of example 9, wherein determining the element subset is based on a temporal sequence of the set of elements.
Example 16

One or more non-transitory computer-readable storage media including instructions that, when executed by one or more processors, cause the one or more processors to perform operations comprising: receiving a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements; generating an augmented training dataset from the training dataset by: determining, from the set of elements, an element subset that comprises the element, determining a synthetic training label for the element subset based on the element-specific label, and generating a synthetic datapoint for the augmented training dataset based on the element subset and the synthetic training label; and training, using the augmented training dataset, the deep set neural network.
Example 17

The one or more non-transitory computer-readable storage media of example 16, wherein the set of datapoints respectively corresponds to a set of historical timepoints and the operations further comprise: receiving an input datapoint that corresponds to a timepoint subsequent to the set of historical timepoints; generating, using an encoder of the deep set neural network, a set of embedding vectors based on a set of input feature vectors of the input datapoint; generating an aggregate embedding vector based on the set of embedding vectors; and outputting, using a decoder of the deep set neural network, a target prediction based on the aggregate embedding vector.
Example 18

The one or more non-transitory computer-readable storage media of example 16, wherein the operations further comprise generating a plurality of synthetic datapoints by iteratively determining, from the set of elements, a plurality of element subsets.
Example 19

The one or more non-transitory computer-readable storage media of example 18, wherein the operations further comprise generating the plurality of synthetic datapoints based on an iteration threshold.
Example 20

The one or more non-transitory computer-readable storage media of example 16, wherein determining the element subset is based on a target subset of the set of elements that is associated with a target data feature.

### Example 21

A computer-implemented method comprising: receiving an input datapoint that corresponds to a timepoint subsequent to a set of historical timepoints; generating, using an encoder of a deep set neural network, a set of embedding vectors based on a set of input feature vectors of the input datapoint, wherein the deep set neural network is trained using an augmented training dataset that has been generated based on: (i) determining, from a set of elements associated with a historical datapoint from the set of historical datapoints, an element subset that comprises an element, (ii) determining a synthetic training label for the element subset based on an element-specific label, and (iii) generating a synthetic datapoint for the augmented training dataset based on the element subset and the synthetic training label; generating an aggregate embedding vector based on the set of embedding vectors; and outputting, using a decoder of the deep set neural network, a target prediction based on the aggregate embedding vector.

### Example 22

A computer-implemented method comprising: receiving a patient population health datapoint that corresponds to a timepoint subsequent to a set of historical timepoints; generating, using an encoder of a deep set neural network, a set of embedding vectors based on a set of patient feature vectors of the patient population health datapoint, wherein the deep set neural network is trained using an augmented training dataset that has been generated based on: (i) determining, from a set of patient elements associated with a historical datapoint from the set of historical datapoints, a patient element subset that comprises a patient element, (ii) determining a synthetic training label for the patient element subset based on a patient element-specific disease label, and (iii) generating a synthetic datapoint for the augmented training dataset based on the patient element subset and the synthetic training label; generating an aggregate embedding vector based on the set of embedding vectors; and outputting, using a decoder of the deep set neural network, a disease prevalence prediction based on the aggregate embedding vector.

### Example 23

The computer-implemented method of examples 1, 21, or 22, wherein the method further comprises training the deep set neural network model.

### Example 24

The computer-implemented method of example 23, wherein the training is performed by the one or more processors.

### Example 25

The computer-implemented method of example 23, wherein the one or more processors are comprised in a first computing entity; and the training is performed by one or more other processors comprised in a second computing entity.

### Example 26

The system of example 9, wherein the operations further comprise training the deep set neural network model.

### Example 27

The system of example 26, wherein the one or more processors are comprised in a first computing entity; and the deep set neural network is trained by one or more other processors comprised in a second computing entity.

### Example 28

The one or more non-transitory computer-readable storage media of example 16, wherein the operations further comprise training the deep set neural network model.

### Example 29

The one or more non-transitory computer-readable storage media of example 28, wherein the one or more processors are comprised in a first computing entity; and the deep set neural network model is trained by one or more other processors comprised in a second computing entity.

### Example 30

A system comprising one or more processors and at least one memory storing processor-executable instructions that, when executed by any of the one or more processors, causes the one or more processors to perform operations comprising: receiving an input datapoint that corresponds to a timepoint subsequent to a set of historical timepoints; generating, using an encoder of a deep set neural network, a set of embedding vectors based on a set of input feature vectors of the input datapoint, wherein the deep set neural network is trained using an augmented training dataset that has been generated based at least in part on: (i) determining, from a set of elements associated with a historical datapoint from the set of historical datapoints, an element subset that comprises an element, (ii) determining a synthetic training label for the element subset based on an element-specific label, and (iii) generating a synthetic datapoint for the augmented training dataset based on the element subset and the synthetic training label; generating an aggregate embedding vector based on the set of embedding vectors; and outputting, using a decoder of the deep set neural network, a target prediction based on the aggregate embedding vector.

### Example 31

A system comprising one or more processors and at least one memory storing processor-executable instructions that, when executed by any of the one or more processors, causes the one or more processors to perform operations comprising: receiving a patient population health datapoint that corresponds to a timepoint subsequent to a set of historical timepoints; generating, using an encoder of a deep set neural network, a set of embedding vectors based on a set of patient feature vectors of the patient population health datapoint, wherein the deep set neural network is trained using an augmented training dataset that has been generated based at least in part on: (i) determining, from a set of patient elements associated with a historical datapoint from the set of historical datapoints, a patient element subset that comprises a patient element, (ii) determining a synthetic training label for the patient element subset based on a patient element-specific disease label, and (iii) generating a synthetic datapoint for the augmented training dataset based on the patient element subset and the synthetic training label; generating an aggregate embedding vector based on the set of embedding vectors; and outputting, using a decoder of the deep set neural network, a disease prevalence prediction based on the aggregate embedding vector.

### Example 32

One or more non-transitory computer-readable storage media including instructions that, when executed by one or more processors, cause the one or more processors to perform operations comprising: receiving an input datapoint that corresponds to a timepoint subsequent to a set of historical timepoints; generating, using an encoder of a deep set neural network, a set of embedding vectors based on a set of input feature vectors of the input datapoint, wherein the deep set neural network is trained using an augmented training dataset that has been generated by: (i) determining, from a set of elements associated with a historical datapoint from the set of historical datapoints, an element subset that comprises an element, (ii) determining a synthetic training label for the element subset based on an element-specific label, and (iii) generating a synthetic datapoint for the augmented training dataset based on the element subset and the synthetic training label; generating an aggregate embedding vector based on the set of embedding vectors; and outputting, using a decoder of the deep set neural network, a target prediction based on the aggregate embedding vector.

### Example 33

One or more non-transitory computer-readable storage media including instructions that, when executed by one or more processors, cause the one or more processors to perform operations comprising: receiving a patient population health datapoint that corresponds to a timepoint subsequent to a set of historical timepoints; generating, using an encoder of a deep set neural network, a set of embedding vectors based on a set of patient feature vectors of the patient population health datapoint, wherein the deep set neural network is trained using an augmented training dataset that has been generated by: (i) determining, from a set of patient elements associated with a historical datapoint from the set of historical datapoints, a patient element subset that comprises a patient element, (ii) determining a synthetic training label for the patient element subset based on a patient element-specific disease label, and (iii) generating a synthetic datapoint for the augmented training dataset based on the patient element subset and the synthetic training label; generating an aggregate embedding vector based on the set of embedding vectors; and outputting, using a decoder of the deep set neural network, a disease prevalence prediction based on the aggregate embedding vector.

1. A computer-implemented method comprising:
receiving, by one or more processors, a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements;
generating, by the one or more processors, an augmented training dataset from the training dataset by:
determining, from the set of elements, an element subset that comprises the element,
determining a synthetic training label for the element subset based on the element-specific label, and
generating a synthetic datapoint for the augmented training dataset based on the element subset and the synthetic training label; and
training, by the one or more processors and using the augmented training dataset, the deep set neural network.

2. The computer-implemented method of claim 1, wherein the set of datapoints comprises a set of feature vectors that are labeled with a set of respectively corresponding training labels.

3. The computer-implemented method of claim 1, wherein the set of datapoints respectively corresponds to a set of historical timepoints and the computer-implemented method further comprises:
receiving an input datapoint that corresponds to a timepoint subsequent to the set of historical timepoints;
generating, using an encoder of the deep set neural network, a set of embedding vectors based on a set of input feature vectors of the input datapoint;
generating an aggregate embedding vector based on the set of embedding vectors; and
outputting, using a decoder of the deep set neural network, a target prediction based on the aggregate embedding vector.

4. The computer-implemented method of claim 1 further comprising generating a plurality of synthetic datapoints by iteratively determining, from the set of elements, a plurality of element subsets.

5. The computer-implemented method of claim 4 further comprising generating the plurality of synthetic datapoints based on an iteration threshold.

6. The computer-implemented method of claim 1, wherein determining the element subset is based on a target subset of the set of elements that is associated with a target data feature.

7. The computer-implemented method of claim 6, wherein determining the element subset further comprises determining a sample size for the element subset, wherein the sample size is based on the target data feature.

8. The computer-implemented method of claim 1, wherein determining the element subset is based on a temporal sequence of the set of elements.

9. A system comprising
one or more processors and
at least one memory storing processor-executable instructions that, when executed by any of the one or more processors, causes the one or more processors to perform operations comprising:
receiving a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements;
generating an augmented training dataset from the training dataset by:
determining, from the set of elements, an element subset that comprises the element,
determining a synthetic training label for the element subset based on the element-specific label, and
generating a synthetic datapoint for the augmented training dataset based on the element subset and the synthetic training label; and
training, using the augmented training dataset, the deep set neural network.

10. The system of claim 9, wherein the set of datapoints respectively corresponds to a set of historical timepoints and the operations further comprise:
receiving an input datapoint that corresponds to a timepoint subsequent to the set of historical timepoints;
generating, using an encoder of the deep set neural network, a set of embedding vectors based on a set of input feature vectors of the input datapoint;
generating an aggregate embedding vector based on the set of embedding vectors; and
outputting, using a decoder of the deep set neural network, a target prediction based on the aggregate embedding vector.

11. The system of claim 9, wherein the operations further comprise generating a plurality of synthetic datapoints by iteratively determining, from the set of elements, a plurality of element subsets.

12. The system of claim 11, wherein the operations further comprise generating the plurality of synthetic datapoints based on an iteration threshold.

13. The system of claim 9, wherein determining the element subset is based on a target subset of the set of elements that is associated with a target data feature.

14. The system of claim 13, wherein to determine the element subset, the operations further comprise determining a sample size for the element subset, wherein the sample size is based on the target data feature.

15. The system of claim 9, wherein determining the element subset is based on a temporal sequence of the set of elements.

16. One or more non-transitory computer-readable storage media including instructions that, when executed by one or more processors, cause the one or more processors to perform operations comprising:
receiving a training dataset for a deep set neural network, wherein (i) the training dataset comprises a set of datapoints and (ii) a datapoint of the set of datapoints comprises (a) a set of elements and (b) a training label that corresponds to the set of elements and is based on an element-specific label of an element within the set of elements;
generating an augmented training dataset from the training dataset by:
determining, from the set of elements, an element subset that comprises the element,
determining a synthetic training label for the element subset based on the element-specific label, and
generating a synthetic datapoint for the augmented training dataset based on the element subset and the synthetic training label; and
training, using the augmented training dataset, the deep set neural network.

17. The one or more non-transitory computer-readable storage media of claim 16, wherein the set of datapoints respectively corresponds to a set of historical timepoints and the operations further comprise:
receiving an input datapoint that corresponds to a timepoint subsequent to the set of historical timepoints;
generating, using an encoder of the deep set neural network, a set of embedding vectors based on a set of input feature vectors of the input datapoint;
generating an aggregate embedding vector based on the set of embedding vectors; and
outputting, using a decoder of the deep set neural network, a target prediction based on the aggregate embedding vector.

18. The one or more non-transitory computer-readable storage media of claim 16, wherein the operations further comprise generating a plurality of synthetic datapoints by iteratively determining, from the set of elements, a plurality of element subsets.

19. The one or more non-transitory computer-readable storage media of claim 18, wherein the operations further comprise generating the plurality of synthetic datapoints based on an iteration threshold.

20. The one or more non-transitory computer-readable storage media of claim 16, wherein determining the element subset is based on a target subset of the set of elements that is associated with a target data feature.
